(19) United States
(12) Patent Application Publication
(10) Pub. No.: US 2017/0290643 A1
(43) Pub. Date: Oct. 12, 2017

(54) INTRAORAL EXPANDER DEVICE

(71) Applicant: Giovanni GIARDINO, Grugliasco (TO) (IT)

(72) Inventor: Giovanni GIARDINO, Grugliasco (TO) (IT)

(21) Appl. No.: 15/514,197

(22) PCT Filed: Sep. 25, 2015
(86) PCT No.: PCT/IB2015/057385

§ 371 Date: Mar. 24, 2017

(30) Foreign Application Priority Data
Sep. 26, 2014 (IT) TO2014A000762

(51) Int. Cl. A61C 7/10

(52) U.S. Cl. CPC A61C 7/10

(57) ABSTRACT

An intra-oral expander device comprises: a transverse expansion assembly, which can be anchored in opposed positions to the upper dental arch and is expandable in a respective plane of action to produce a palatal expansion; and a longitudinal expansion assembly, which is carried by the transverse expansion assembly and is able to exert an action of postero-anterior thrust on the upper front teeth. The longitudinal expansion assembly is mounted on the aforesaid transverse expansion assembly, with possibility of adjustment of the orientation with respect to the plane of action of said transverse expansion assembly.

### TECHNICAL FIELD

The present description relates to intra-oral expander devices.

One or more embodiments may be applied, for example, to intra-oral rapid-palatal-expander devices.

### TECHNOLOGICAL BACKGROUND

Rapid palatal expansion is a technique applied in orthodontics in order to correct defects, such as for example maxillary hypoplasia, a defect characterized by the reduction of the transverse diameter of the upper jaw.

Maxillary hypoplasia may be the cause of dental malocclusion and an under-development in a sagittal and/or transverse direction of the lower jaw.

It is consequently possible to undertake protocols of treatment in order to correct both maxillary hypoplasia and the resulting dento-alveolar and muscular imbalance.

A device for intervening on and correcting such anomalies is the rapid palatal expander (also known as “maxillary expansion appliance” or “orthodontic expander”), i.e., a device used for treating, for example, cases of skeletal under-development of the upper jaw in subjects in the developing phase.

The main purpose of the rapid palatal expander is to restore the correct transverse diameter of the upper jaw.

It may be a fixed device—inserted in the palate and anchored, for example, to the first upper molars—provided with a screw, turning of which enables generation of a bilateral force that is able to stimulate the median suture of the palate, with consequent variation of the transverse width of the jaw bone as a whole.

The action of the expander is particularly effective in the age of development when the median suture of the palate is not yet ossified.

For adult patients, skeletal expansion can be obtained with an orthopedic-surgical treatment that envisages application of devices resembling the ones used in paediatric patients, activated after surgical opening of the suture.

The action of rapid palatal expansion may moreover be associated to the action of correction of other types of defects. There are cases, in fact, where, in addition to a component of deficit of the transverse dimension of the upper jaw, there may also be present a component of antero-posterior discrepancy such as, for example, retroposition of the upper jaw with respect to the lower jaw.

In these cases, once the correct transverse diameter of the upper jaw is obtained with the action of the rapid expander, it is consequently necessary to favour advance of the upper jaw and/or exert a postero-anterior thrust on the upper front teeth.

In the first case, i.e., to favour advance of the upper jaw in toto a face mask is generally applied to the patient, for example the so-called “Delaire mask”, designed to exert from outside a tensile force on the upper jaw.

However, the use of devices such as the Delaire mask presents a series of disadvantages, such as, for example, the need to wear the mask constantly every day for may hours a day, reddening of the skin caused by the pressure exerted by the mask on the chin, the need to check periodically that the chin support does not rest excessively up against the gums of the lower teeth because it could injure them, the evident anti-aesthetic effect, and the consequent poor acceptance of the corrective treatment by the patient.

In the second case, i.e., to favour postero-anterior displacement of the upper front teeth, vestibular orthodontic attachments are generally applied (these devices make it possible to exert an orthodontic tensile force).

Vestibular orthodontic attachments are generally glued to the incisors, which, thanks to appropriately modelled intra-oral arches, are subjected to a tensile force.

The disadvantages deriving from the use of these devices arise from:

the presence of a vestibular encumbrance and corresponding discomfort for the patient with possible laceration of the upper vestibular fornix;

the high risk of detachment of the attachments themselves and hence of immediate interruption of the therapy, with consequent need for the patient to go along to a health structure for restoring the anchorage; and

the possibility that the necessary vestibular space on the front teeth is lacking, for example in subjects having an anterior reverse bite.

Object and Summary

The object of one or more embodiments is to overcome the drawbacks outlined above.

According to one or more embodiments, the above object can be achieved thanks to an intra-oral expander device having the characteristics recalled in the ensuing claims.

The claims form an integral part of the technical teaching provided herein in relation to the embodiments.

One or more embodiments enable an intra-oral device to be obtained, comprising a transverse expansion assembly (orthopedic expansion), which is able to produce an expansion of the palate, and a longitudinal expansion assembly (orthopedic and/or orthodontic expansion), which is able to exert an action of postero-anterior thrust on the upper front teeth.

The device described consequently enables promotion of postero-anterior orthopedic and/or orthodontic expansion, without the need to add, once the stage of palatal orthopedic expansion is terminated, other components such as direct attachments, elastic elements, wires, masks, etc. in order to exert a tensile force on the upper incisors according to the procedures currently in use.

One or more embodiments of the device described may afford one or more of the following advantages:

orthodontic treatment is less invasive than the procedures currently in use and consequently is more comfortable for the patient;

orthodontic treatment can start early, even in pre-school age, in so far as it does not require collaboration on the part of the patient for correct use;

the device is entirely applied on the palate, and this leads to a better acceptance of the treatment by the patient;

orthodontic treatment can be carried out also on patients who have malocclusions such as anterior reverse bite, where, on account of the lack of the space necessary, it is not possible to mount vestibular attachments from outside on the four upper incisors.

### BRIEF DESCRIPTION OF THE DRAWINGS

One or more embodiments will now be described, purely by way of non-limiting example, with reference to the annexed drawings, in which:

FIG. 1 is a perspective view of a device according to embodiments that can be fixed to the palate of a patient;

FIGS. 2 and 3 illustrate in greater detail parts of the device of FIG. 1; and

FIGS. 4 and 5 are more detailed views according to the arrows IV and V, respectively, of FIG. 1.

### DETAILED DESCRIPTION

In the ensuing description, various specific details are illustrated aimed at providing an in-depth understanding of examples of one or more embodiments. The embodiments may be obtained without one or more of the specific details, or with other methods, components, materials, etc. In other cases, known structures, materials, or operations are not illustrated or described in detail so that various aspects of the embodiments will not be obscured. Reference to “an embodiment” or “one embodiment” in the framework of this description is intended to indicate that a particular configuration, structure, or characteristic described in relation to the embodiment is comprised in at least one embodiment. Hence, phrases such as “in an embodiment” or “in one embodiment” that may be present in various points of the present description do not necessarily refer to one and the same embodiment. Furthermore, particular conformations, structures, or characteristics may be combined in adequately in one or more embodiments.

The references used herein are merely provided for convenience and hence do not define the sphere of protection or the scope of the embodiments.

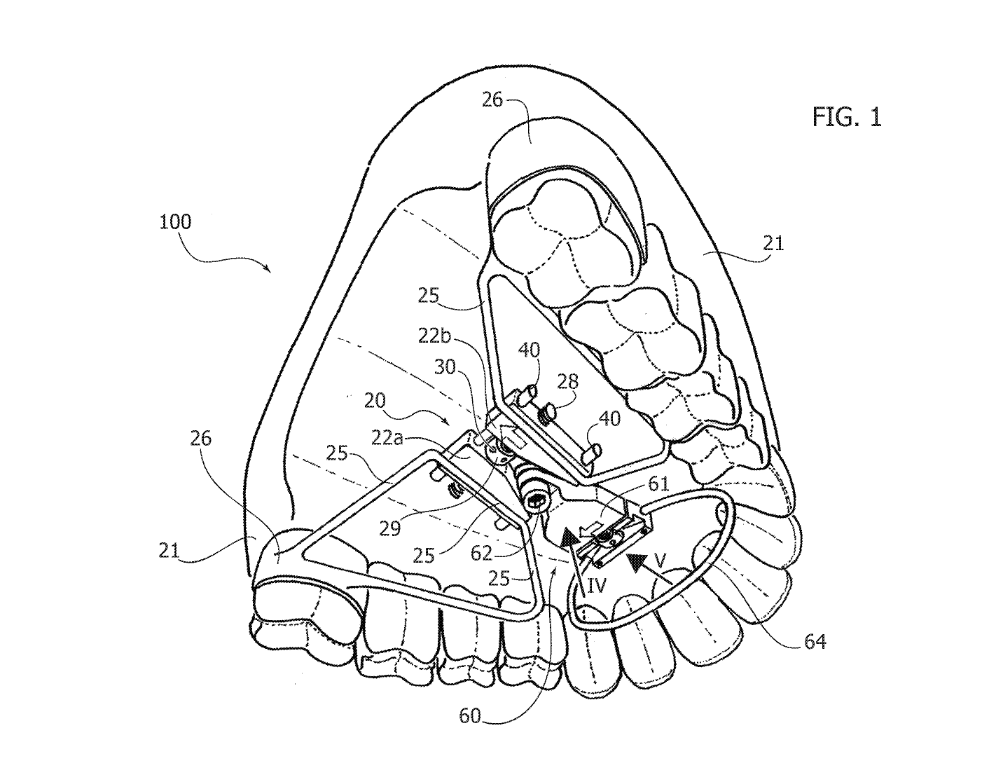

In FIG. 1, the reference number 100 designates as a whole an intra-oral expander device according to one or more embodiments. In the representation of FIG. 1, the device 100 is illustrated applied to the palate of a patient. For reference, the view of FIG. 1 corresponds to an ideal point of view set approximately on the right shoulder of the patient.

In one or more embodiments, the device 100 comprises a transverse orthopedic expansion assembly 20 that can be anchored in opposed positions 21 of the upper dental arch. This orthopedic expansion assembly 20 is expandable in a direction transverse with respect to the dental arch in a respective plane of action (substantially horizontal, if reference is made to a normal upright posture of the head of the patient) to produce a palatal expansion according to criteria in themselves known.

The device 100 further comprises a longitudinal orthopedic and/or orthodontic expansion assembly 60, which is carried by the orthopedic expansion assembly 20 and is able to exert an action of postero-anterior thrust on the upper front teeth in a longitudinal direction with respect to the dental arch.

In one or more embodiments, the longitudinal expansion assembly 60 can be mounted on the transverse expansion assembly 20, with possibility of adjustment of the orientation with respect to the plane of action of the transverse expansion assembly 20.

In one or more embodiments, the above possibility of adjustment may enable variation of the overall inclination of the longitudinal expansion assembly 60 with respect to the plane of action of the transverse expansion assembly 20, i.e., variation of the angle of the dihedron ideally formed by the longitudinal expansion assembly 60 with respect to the transverse expansion assembly 20.

In one or more embodiments, the transverse expansion assembly 20 may comprise two mobile elements 22a, 22b, which can be anchored, as described more fully in what follows, on opposed portions of the upper dental arch. The mobile elements 22a, 22b are slidable in recession away from one another to produce palatal expansion.

In one or more embodiments, each of the two mobile elements 22a, 22b may comprise one or more palatal “arms” 25.

In the embodiment exemplified in FIG. 1, the palatal arms 25 may be annular elements with a substantially trapezoidal geometry. In particular, in this embodiment, each palatal arm 25 may include a filiform element of metal material shaped according to the aforesaid geometry, i.e., so as to define four perimetral segments that define a quadrilateral with trapezoidal geometry.

In one or more embodiments, the device 100 may comprise at least one anchoring element 26 fixed to one end of the palatal arms 25 and configured for being coupled (anchored) to a tooth of the patient.

Once again with reference to FIG. 1, in one or more embodiments, each palatal arm 25 may include an anchoring element set at an external and rear vertex of the palatal arm itself. The term “external” is here used to indicate the vertices directly facing the dental arch, whereas the term “rear” indicates the position with reference to the palate.

In the embodiment exemplified in FIG. 1, the arms 25 are fixed to the elements 22a, 22b on the side opposite to the one facing the palate. In one or more embodiments, the arms 25 are fixed to the elements 22a, 22b on the side facing the palate, or in other positions.

In one or more embodiments, each anchoring element 26 may be obtained as an annular element with cylindrical geometry having a height such as to enable the element to be fitted on a tooth covering a substantial portion thereof.

In the representation of FIG. 1, the elements 26 are represented, by way of example, fitted on tooth 27 and on tooth 17 (according to the FDI international dental numbering system). In one or more embodiments, anchoring elements 26 may moreover be provided for anchorage on any dental element that guarantees stability, for example on teeth 16 and 26 and, simultaneously, on teeth 14 and 24 (according to the FDI international dental numbering system).

In this way, the ensemble formed by each mobile element 22a, 22b, including the corresponding palatal arm 25, comes to constitute an element that can be anchored on a respective portion of the upper dental arch, the portions being opposed to one another.

In one or more embodiments, the anchoring element may alternatively be obtained as a channel, i.e., a perimetral shell or band, for example of metal coated with resin, which partially or completely includes more than one dental element, for example teeth 16-15-14 on one side of the dental arch and teeth 26-25-24 on the opposite side of the dental arch.

In one or more embodiments, the elements 26 for anchorage to the teeth may be positioned with an asymmetrical distribution with respect to the opposed portions of the upper dental arch.

Furthermore, in one or more embodiments, the device 100 may present, on opposed portions of the dental arch, a different number of elements 26 for anchorage to the teeth.

In one or more embodiments, the mobile elements 22a, 22b of the transverse expansion assembly 20 may be mounted on at least one (and optionally at least two) slide guides 40. Exemplified in FIGS. 1 to 3 is a device 100 comprising two slide guides 40, which are mutually parallel and, optionally, of the same axial length. In one or more embodiments, the slide guide 40 (or, in the case where a number of guides 40 are present, at least the slide guide 40 that is to face the front teeth) may present a non-circular cross-sectional profile, for example a polygonal (e.g., hexagonal or octagonal) profile.

In one or more embodiments, in order to govern the movement of relative sliding (in recession and approach) of the mobile elements 22a, 22b, the device 100 may comprise a screw 28 (e.g., of the type that may be defined as “double-stem screw”) coupled to the mobile elements 22a, 22b to enable screw adjustment of their relative position.

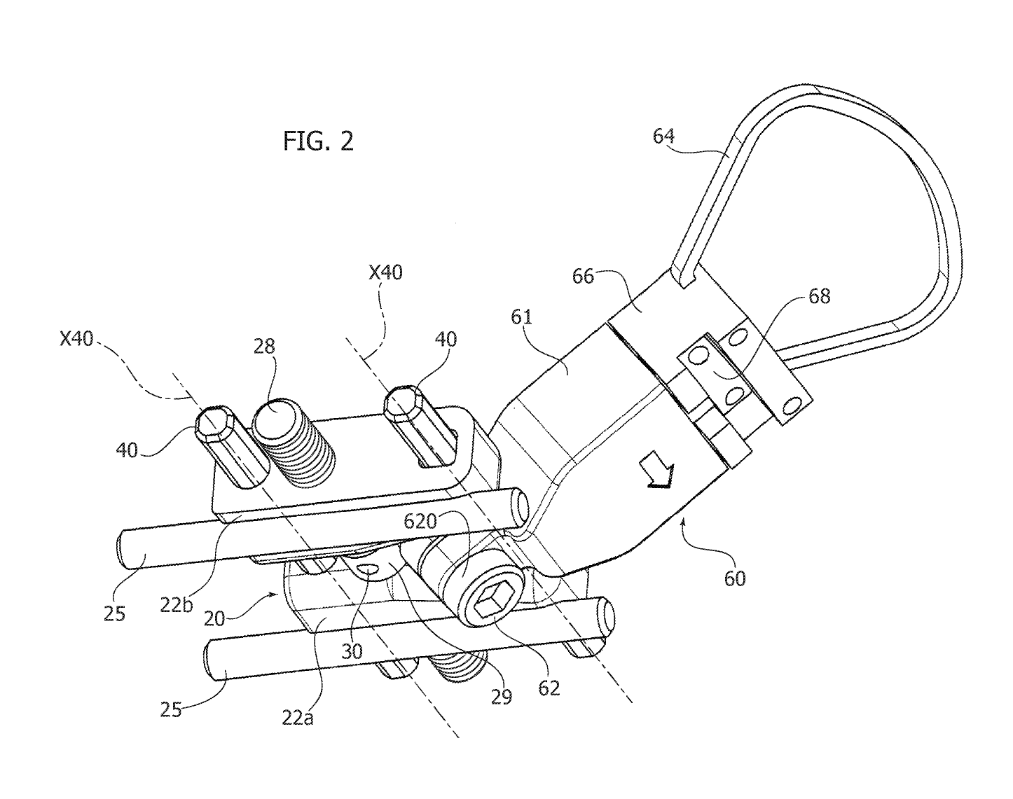

In one or more embodiments, as illustrated in greater detail in FIG. 2, the screw 28 may comprise a manoeuvring bushing 29 of a cylindrical shape located in a median position between the two stems, which has radial holes 30 configured for receiving an actuation means, for example a manoeuvring pin or rod.

To obtain a symmetrical movement (mutual recession or approach) of the mobile elements 22a, 22b the two stems of the screw may have opposite threads (a right-hand thread and a left-hand thread) and are each engaged in a respective internal screw (threaded hole) provided in the corresponding mobile element 22a, 22b .

On the body of the mobile elements 22a, 22b, there may be provided markings (for example, obtained via laser) representing arrows that identify the direction of rotation that enables palatal expansion, the maximum value of expansion that can be achieved, the number identifying the production lot, etc.

It will be appreciated, on the other hand, that in one or more embodiments the kinematic arrangement for governing movement of expansion/contraction of the elements 22a and 22b may be complementary to the one exemplified herein.

In the embodiment of FIG. 1, the longitudinal expansion assembly 60 is mounted on the front slide guide 40, with possibility of adjustment of the mounting position.

Terms such as “transverse”, “longitudinal”, “anterior” or “front”, “posterior” or “rear” here refer —as for the convention adopted previously—to the palate/dental arch.

As has already been said, in one or more embodiments, the above possibility of adjustment may enable variation of the overall inclination of the longitudinal expansion assembly 60 with respect to the plane of action of the transverse expansion assembly 20, namely the angle of the dihedron ideally formed by the longitudinal expansion assembly 60 with respect to the transverse expansion assembly 20.

For instance, the position of the longitudinal expansion assembly 60 may be adjusted by articulation thereof to the transverse expansion assembly 20 about an axis of articulation X40, which may, in one or more embodiments, coincide with the longitudinal axis of the front guide 40.

As illustrated in FIG. 2, in one or more embodiments, the articulation may be obtained by fixing of the longitudinal expansion assembly 60 to the front guide 40.

For instance, in one or more embodiments, the guide 40 situated in the rear position may engage, with possibility of sliding, a pair of holes with circular section made in the mobile elements 22a, 22b . The analogous coupling arrangement for the guide 40 situated in the front position may, instead, envisage engagement, with possibility of sliding, in a pair of holes with non-circular, for example polygonal, section, with a cross-sectional profile complementary to the cross-sectional profile of the front guide 40.

Thanks to the above coupling, the front guide 40 is blocked against movement of rotation about its longitudinal axis and can thus be used as (adjustable) fixing element of the longitudinal expansion assembly 60 to the transverse expansion assembly 20.

In one or more embodiments, as illustrated in FIGS. 1, 2, and 4, the longitudinal expansion assembly 60 may comprise a body 61 and a clamp-fixing part 62.

FIG. 2 shows a screw clamp 62 that can be fastened to the front slide guide 40 of the transverse expansion assembly 20. The clamp-fixing part 62 enables regulation of the tightening force by means of a screw element 620.

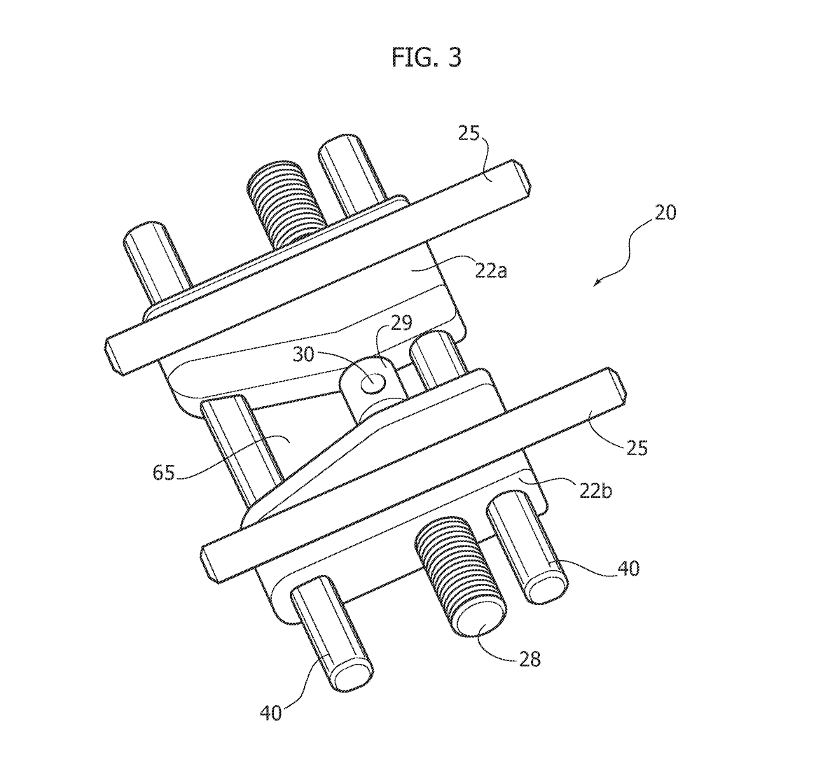

The polygonal cross-sectional profile of the guide gripped by the clamp may enable a firm fixing configuration to be achieved (e.g., by shape fit), possibly enabling a step-by-step adjustment. In one or more embodiments, as may be appreciated, for example, in the view of FIG. 3, the transverse expansion assembly 20 may comprise a receiving recess 65 (defined, for example, by the geometry of the mobile elements 22a, 22b), which is designed to receive the longitudinal expansion assembly 60, in particular the clamp-fixing part 62.

Consequently, in one or more embodiments, the screw 28 for governing the transverse expansion assembly 20 may be located in an eccentric position away from the longitudinal expansion assembly 60.

In one or more embodiments, the longitudinal expansion assembly 60 may be adjustable away from the transverse expansion assembly 20.

As illustrated in FIGS. 1, 2, and 5, in one or more embodiments, the longitudinal expansion assembly may comprise an arch 64, for example a filiform arch. This arch may be spring-like and is designed to exert an action of postero-anterior thrust when it is in contact with the upper front teeth.

In one or more embodiments, the arch 64 may be carried by a slide 66, the position of which can be adjusted with respect to the transverse expansion assembly 20.

FIG. 5 shows in detail the structure of a possible example of embodiment of the slide 66, which comprises:

a groove 660 delimited by walls with contrast surfaces facing one another; and

a cradle 661 provided in a rear wall (with reference to the palate) of the groove.

Two longitudinal guides 74 inserted in respective housings present in the body 61 of the longitudinal expansion assembly 60 may be coupled to the slide 66, with possibility of axial movement in a longitudinal direction.

Adjustment of the position of the slide 66 with respect to the body 61 of the longitudinal expansion assembly 60 may be made via a screw 68 engaged within the body 61 of the longitudinal expansion assembly 60 and at the same time coupled to the slide 66.

The screw 68 comprises a threaded stem 69 engaged in the body 61, and a head 70, preferably of a cylindrical shape, which has radial holes 72 designed to receive an actuation means, such as a manoeuvring pin or rod.

The head 70 is housed in the groove 660, whilst the portion of the stem 69 immediately adjacent to the head 70 is housed in the cradle 661. In this way, the head 70 is engaged between the contrast surfaces that delimit the groove 660, thus bringing about coupling with the slide 66.

Also in this case, it will be appreciated that, in one or more embodiments, the kinematic arrangement for governing movement of the slide 66 may be complementary to the one exemplified herein.

In one or more embodiments, the arch 64 may be a single element that can be made to measure by the operator, and then be subsequently fixed to the slide 66, for example, via two grub screws housed in the holes visible in FIG. 2, on the same surface where the holes of the screw 68 can be reached.

This operation can be carried out after the position on the palate has been chosen as definitive.

In one or more embodiments, the plane of action of the arch 64 may be parallel to the movement of the slide 66, with the possibility of being very “high” on the palate practically flush with the item 66 so as to be able to contact the incisors on their neck.

In one or more embodiments, the arch 64 may have a preferably square cross section (e.g., a 0.014-in or else a 0.016-in nickel-titanium wire).

In one or more embodiments, the arch 64 may be made in such a way that it does not lose its plane of action even following upon repeated cyclic loads, such as those involved in mastication.

This result may be obtained, for example, by getting each grub screw to pinch the surface of the wire in such a way that the latter undergoes only elastic, and not plastic, deformation.

In one or more embodiments, the inlet hole in the slide 66 may have a square cross section.

A device 100 as exemplified herein is suited to temporary application to the palate of a patient in order to impress:

an “orthopedic” action of expansion in a transverse direction with respect to the dental arch that results in opening of the palatal suture and consequent expansion of the palate; and

an “orthopedic and/or orthodontic” action of thrust exerted on the four upper incisors, aimed, for example, at obtaining a postero-anterior longitudinal expansion.

It will be appreciated that a device 100, as exemplified herein, is suited to performing the aforesaid actions also in a way at least partially concomitant, overcoming the need to await completion of the orthopedic action of expansion before starting an orthodontic action of thrust.

In one or more embodiments, a device 100 as exemplified herein is suited to being used according to the modalities described in what follows by way of example.

Once the device has been applied to the palate, the operator will fix it to the teeth, generally to the first upper molars, by means of the anchoring elements 26.

In order to exert the action of transverse expansion and produce palatal expansion, the operator will turn screw 28. With rotation of the screw 28, the operator can bring about mutual recession of the mobile elements 22a, 22b and of the palatal arms 25 towards the dental arch. This displacement will exert a bilateral force on the palatal suture, with a consequent action of expansion of the palate.

The arrow marking (see FIG. 1) impressed on the mobile element 22b indicates, by way of example, the direction of rotation to be imparted on the screw 28 in order to obtain recession of the mobile elements 22a, 22b.

In order to impart a movement of rotation on the screw 28, the operator will insert a manoeuvring pin in a radial hole 30 present in the manoeuvring bushing 29.

The manoeuvring bushing 29 may have a variable number of radial holes 30, for example equidistant from one another. The operator may choose to turn the screw, for example, by a quarter of a turn or an eighth of a turn.

The angle of rotation of the screw will be chosen by the operator in order to obtain the desired recession of the mobile elements 22a, 22b .

Once expansion has been obtained, the screw 28 may possibly be blocked with tie wire, cold resin, or composite to prevent any return thereof.

The device 100 may further comprise an end-of-travel block that can be operated to achieve maximum expansion of the mobile elements 22a, 22b.

In order to exert the action of longitudinal expansion, the operator may act on the screw 68 of the expansion assembly 60, imparting a rotation thereon. In particular, the operator, from the outside of the oral cavity, will insert a manoeuvring pin in one of the radial holes 72 present in the head 70 of the screw 68 and will cause rotation thereof. According to the direction of rotation of the screw 68, the head 70 may undergo a movement of approach to or recession from the body 61 of the longitudinal expansion assembly 60.

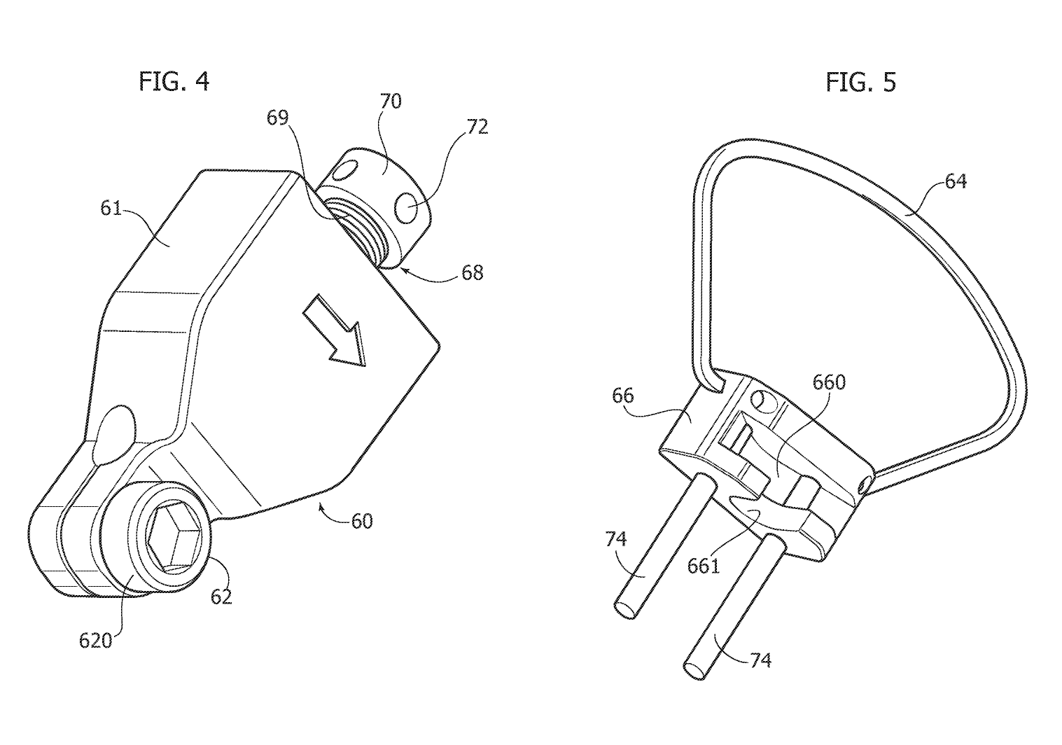

The arrow marking impressed on the body 61 of the expansion assembly 60 (see FIG. 4) indicates, by way of example, the direction of rotation to be imparted on the screw 68 in order to obtain a movement in a postero-anterior direction (hence a movement of recession from the body 61 of the longitudinal expansion assembly 60) of the screw 68.

As described previously, the screw 68 is coupled to the slide 66 that carries the arch 64. Consequently, the rotation of the screw 68 will cause displacement of the arch 64 in a postero-anterior direction from the body 61 of the longitudinal expansion assembly 60 towards the surface of the four upper incisors.

The head 70 of the screw may have a variable number of radial holes 72 distributed in such a way as to determine, for example, a rotation of the screw by a quarter of a turn or an eighth of a turn.

The angle of rotation of the screw will be chosen by the operator in order to obtain the desired degree of displacement of the arch 64 from the body 61 of the longitudinal expansion assembly 60.

In one or more embodiments, each of the elements of the intra-oral expander described may be made, for example, of stainless steel. Alternatively, other biocompatible and anallergic materials may be used, such as, for example, titanium or gold applied on the intra-oral expander by means of a galvanizing process.

Of course, without prejudice to the underlying principle, the embodiments and the details of construction may vary, even significantly, with respect to what has been illustrated herein purely by way of non-limiting example, without thereby departing from the extent of protection.

The above extent of protection is defined by the annexed claims.

1. An intraoral expander device including:
a transversal expansion assembly for anchoring at opposed positions in the superior dental arch and expandable in a respective action plane for producing palatal expansion, and
a longitudinal expansion assembly, carried by said transversal expansion assembly for exerting a postero-anterior urging force on the upper front teeth, said longitudinal expansion assembly mounted on said transversal expansion assembly with an adjustable orientation with respect to the action plane of said transversal expansion assembly.

2. The intraoral expander device of claim 1, wherein said longitudinal expansion assembly is mounted on said transversal expansion assembly with an adjustable tilt orientation with respect to the action plane of said transversal expansion assembly.

3. The intraoral expander device of claim 1, wherein said transversal expansion assembly includes two elements for anchoring at opposed positions in the superior dental arch, said elements slidable away from each other to produce said palatal expansion.

4. The intraoral expander device of claim 3, including a screw coupled to said elements for regulating the relative sliding movement thereof.

5. The intraoral expander device of claim 3, wherein the transversal expansion assembly includes at least one front sliding guide between said two elements, said longitudinal expansion assembly being mounted on said front sliding guide with an adjustable mounting position.

6. The intraoral expander device of claim 5, wherein:
said at least one sliding guide is a guide with a non-circular cross sectional profile, and/or
said longitudinal expansion assembly includes a clamp-like fastening portion, preferably of the screw-actuatable type, for fastening onto said sliding guide.

7. The intraoral expander device of claim 1, wherein said transversal expansion assembly includes an accommodation recess for said longitudinal expansion assembly, and/or a control screw for controlling expansion of the transversal expansion assembly arranged at a position located eccentrically away from said longitudinal expansion assembly.

8. The intraoral expander device of claim 1, wherein said longitudinal expansion assembly includes an arch, preferably of a resilient type, for applying an urging force on the upper front teeth.

9. The intraoral expander device of claim 1, wherein said longitudinal expansion assembly is adjustable away from said transversal expansion assembly.

10. The intraoral expander device of claim 8, including a slide carrying said arch, said slide being adjustable in position, preferably by a screw, with respect to the transversal expansion assembly.
